(19) United States
(12) Patent Application Publication
(10) Pub. No.: US 2022/0399592 A1
(43) Pub. Date: Dec. 15, 2022

(54) SYSTEM FOR BATTERY MANAGEMENT OF A BATTERY PACK IN ELECTRIC AIRCRAFT

(71) Applicant: BETA AIR, LLC, SOUTH BURLINGTON, VT (US)

(72) Inventors: Stuart Denson Schreiber, Essex, VT (US); Nathan William Joseph Wiegman, Essex Junction, VT (US); Tom Michael Hughes, Bristol, VT (US)

(73) Assignee: BETA AIR, LLC, SOUTH BURLINGTON, VT (US)

(21) Appl. No.: 17/348,516

(22) Filed: Jun. 15, 2021

(51) Int. Cl. H01M 10/653; H01M 10/613; H01M 10/647; H01M 50/209; H01M 50/249

(52) U.S. Cl. CPC H01M 10/653; H01M 10/613; H01M 10/647; H01M 50/209; H01M 50/249; H01M 10/052

(57) ABSTRACT

A system and method for management of a battery pack for an electric aircraft.

The present invention generally relates to the field of battery management for electric vehicles. In particular, the present invention is directed to a system and method for battery management for an electric aircraft.

### BACKGROUND

Modern electric aircraft batteries are prone to overheating and as such require containers with insulation to separate the battery cells from one another. The containers to hold a plurality of battery cells may be bulky and degrade the energy density of battery packs.

### SUMMARY OF THE DISCLOSURE

In an aspect, a system for thermal management of battery cells of an electric aircraft is described herein. The system may include a plurality of battery cells configured to power an electric aircraft, and a barrier coupled to the plurality of battery cells wherein the battery is configured to prevent lithium ejecta from traveling from at least one battery cell of the plurality of battery cells to an adjacent battery cell of the plurality of battery cells.

These and other aspects and features of non-limiting embodiments of the present invention will become apparent to those skilled in the art upon review of the following description of specific non-limiting embodiments of the invention in conjunction with the accompanying drawings.

### BRIEF DESCRIPTION OF THE DRAWINGS

For the purpose of illustrating the invention, the drawings show aspects of one or more embodiments of the invention. However, it should be understood that the present invention is not limited to the precise arrangements and instrumentalities shown in the drawings, wherein:

FIG. 1 is a front view of an exemplary embodiment of a battery pack;

FIG. 2 is front view of an exemplary embodiment of a battery cell;

FIG. 3 is front view of an exemplary embodiment of a barrier positioned next to a battery pack;

FIG. 4 is front view of an exemplary embodiment of battery pack with a sensor board;

FIG. 5 is a front view of an exemplary embodiment of an electric aircraft;

FIG. 6 is a block diagram of an exemplary embodiment of a computing system; and

FIG. 7 is a flowchart of an exemplary embodiment of a method of managing a battery pack.

### DETAILED DESCRIPTION

In the following description, for the purposes of explanation, numerous specific details are set forth in order to provide a thorough understanding of the present invention. It will be apparent, however, that the present invention may be practiced without these specific details. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims.

Described herein is a system for management of a battery pack of an electric aircraft. The system may include a battery pack that may be configured to power an electric aircraft. In some embodiments, the battery pack may have a plurality of battery cells. In some embodiments, the battery pack may have a barrier. In some embodiments, the barrier may be incorporated into the battery pack. In some embodiments, the barrier may be configured to prevent ejecta from at least a battery cell of the plurality of battery cells from traveling outside of the battery pack. In some embodiments, a sensor board may be configured to detect a physical change of the battery pack. In some embodiments, the battery pack may include a flexible casing. In some embodiments, the plurality of battery cells may be pouch cells. In some embodiments, the plurality of battery cells may be lithium-ion cells. In some embodiments, the barrier may include a carbon fiber sheet. In some embodiments, the barrier may include two or more carbon fiber sheets. In some embodiments, the barrier may include a carbon fiber epoxy. In some embodiments, the carbon fiber epoxy may include a gel. In some embodiments, the carbon fiber epoxy may be a foam. In some embodiments, the barrier may be configured to be positioned in a corner of the battery pack. In some embodiments, the barrier may be configured to be positioned at a group of seams of the battery pack. In some embodiments, the barrier may be configured to reduce a thermal energy of a lithium ejecta of a battery pack. In some embodiments, the sensor board may be configured to measure temperature.

Described herein is a method for management of a battery pack in an electric aircraft. In some embodiments, the method includes selecting a battery pack configured to power an electric aircraft, wherein the battery pack includes a plurality of battery cells. In some embodiments, the method includes selecting a battier to be incorporated into the battery pack. In some embodiments, the method includes incorporating the barrier in at least a portion of the battery pack to prevent lithium ejecta from travelling outside the battery pack. In some embodiments, the method includes optimizing a positioning of the barrier in the battery pack based on data measured from the sensor board. In some embodiments, the battery pack may include lithium-ion pouch cells. In some embodiments, the barrier may include carbon fiber. In some embodiments, the barrier may include a carbon fiber in sheet form. In some embodiments, the barrier may include a carbon fiber in an epoxy form. In some embodiments, the barrier may be configured to cool down a thermal energy of a lithium ejecta of a battery pack.

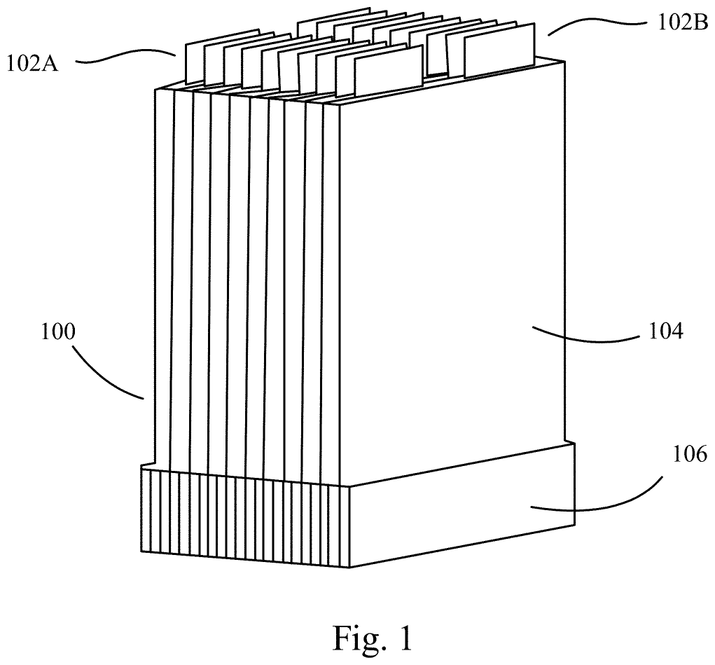

Referring now to FIG. 1, an illustration of an exemplary embodiment of a battery pack 100 is shown. In some embodiments, battery pack 100 may be made from a plurality of battery cells 104. In some embodiments, the plurality of battery cells 104 may be lithium-ion pouch cells. In some embodiments, battery pack 100 may be configured to hold 16 battery cells. In other embodiments, battery pack 100 may be configured to hold more or less than 16 battery cells. Battery pack 100 may include conductive foil tabs 102A-B. In some embodiments, conductive foil tabs 102A-B may be electrically connected to electrodes located inside a battery cell 104. In some embodiments, conductive foil tabs 102A-B may be sealed to an outside section of a battery cell 104. The battery cells 104 in the battery pack 100 may be electrically configured to connect to one another. In one embodiment, battery cells 104 of battery pack 100 may have an insulating barrier. In some embodiments, battery cells 104 of battery pack 100 may be configured in series and/or in parallel. In some embodiments, battery cells 104 may be positioned in one row in the battery pack 100. In other embodiments, battery cells 104 may be positioned in multiple rows in the battery pack 100. In some embodiments, battery cells 104 may be in a staggered arrangement in battery pack 100.

In some embodiments and still referring to FIG. 1, battery cells 104 may be disposed and/or arranged within a respective battery pack 100 in groupings of any number of columns and rows. In some embodiments, any two adjacent rows of battery cells 104 may be offset by a distance equal to a width or length of a battery cell 104. This arrangement of battery cells 104 is only a non-limiting example and in no way precludes other arrangement of battery cells. In some embodiments, battery cells 104 may be fixed in position by a battery cell retainer 106. Battery cells 104 may each comprise a cell configured to include an electrochemical reaction that produces electrical energy sufficient to power at least a portion of an electric aircraft. In some embodiments, battery cells 104 may be electrically connected in series, in parallel, or a combination of series and parallel. Series connection, as used herein, comprises wiring a first terminal of a first cell to a second terminal of a second cell and further configured to comprise a single conductive path for electricity to flow while maintaining the same current (measured in Amperes) through any component in the circuit. Battery cells 104 may use the term ‘wired’, but one of ordinary skill in the art would appreciate that this term is synonymous with ‘electrically connected’, and that there are many ways to couple electrical elements like battery cells 104 together. As an example, battery cells 104 may be coupled via prefabricated terminals of a first gender that mate with a second terminal with a second gender. Parallel connection, as used herein, comprises wiring a first and second terminal of a first battery cell to a first and second terminal of a second battery cell and further configured to comprise more than one conductive path for electricity to flow while maintaining the same voltage (measured in Volts) across any component in the circuit. Battery cells 104 may be wired in a series-parallel circuit which combines characteristics of the constituent circuit types to this combination circuit. Battery cells 104 may be electrically connected in any arrangement which may confer onto the system the electrical advantages associated with that arrangement such as high-voltage applications, high-current applications, or the like. In some embodiments, battery cell retainer 106 may employ a staggered arrangement to allow more battery cells 106 to be disposed closer together than in columns and rows like in a grid pattern. The staggered arrangement may also be configured to allow better thermodynamic dissipation. In other embodiments, the cell retainer 106 may hold the battery cells 104 in a square or grid-like pattern.

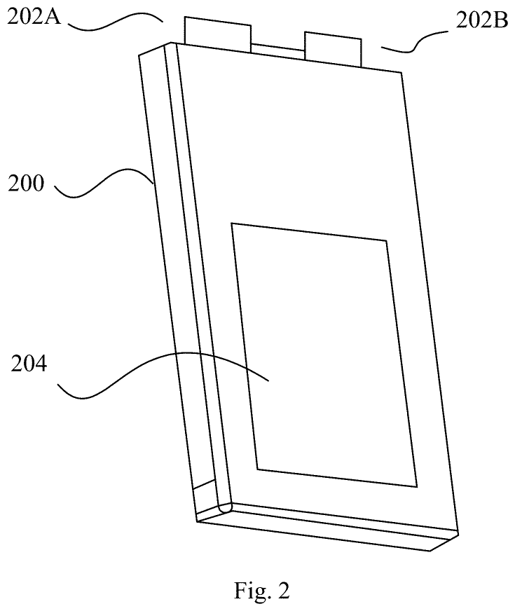

Referring now to FIG. 2, an exemplary embodiment of a battery cell 200 is illustrated. In some embodiments, battery cell 200 may include a pouch cell. As used in this disclosure, “pouch cell” is a battery cell or module that includes a pouch 204. In some cases, a pouch cell may include or be referred to as a prismatic pouch cell, for example when an overall shape of pouch is prismatic. In some cases, a pouch cell may include a pouch 204 which is substantially flexible. Alternatively or additionally, in some cases, a pouch 204 may be substantially rigid. In some cases, pouch 204 may include a polymer, such as without limitation polyethylene, acrylic, polyester, and the like. In some case, pouch 204 may be coated with one or more coatings. For example, in some cases, pouch 204 may have an outer surface. In some embodiments, the outer surface may be coated with a metalizing coating, such as an aluminum or nickel containing coating. In some cases, pouch coating be configured to electrically ground and/or isolate pouch, increase pouches impermeability, increase pouches resistance to high temperatures, increases pouches thermal resistance (insulation), and the like. An electrolyte may be located in pouch 204. In some cases, the electrolyte may comprise a liquid, a solid, a gel, a paste, and/or a polymer. In some embodiments, the electrolyte may be a lithium salt such as LiPF6. In some embodiments, the lithium salt may be lithium hexafluorophosphate, lithium tetrafluoroborate, lithium perchlorate, or other lithium salts. In some embodiments, the lithium salt may be in an organic solvent. In some embodiments, the organic solvent may be ethylene carbonate, dimethyl carbonate, diethyl carbonate or other organic solvents. In some embodiments, the electrolyte may wet or contact one or both of at least a pair of foil tabs Battery cell 200 may include without limitation a battery cell using nickel-based chemistries such as nickel cadmium or nickel metal hydride, a battery cell using lithium-ion battery chemistries such as a nickel cobalt aluminum (NCA), nickel manganese cobalt (NMC), lithium iron phosphate (LiFePO4), lithium cobalt oxide (LCO), lithium manganese oxide (LMO), a battery cell using lithium polymer technology, and/or metal-air batteries. Battery cell 200 may include lead-based batteries such as without limitation lead acid batteries and lead carbon batteries. Battery cell 200 may include lithium sulfur batteries, magnesium ion batteries, and/or sodium ion batteries. Battery cell 200 may include solid state batteries or supercapacitors or another suitable energy source. In some embodiments, the battery cell 200 may be a pouch cell. In other embodiments, the battery cell 200 may be a prismatic, cylindrical, or other type of battery cell. In some embodiments, the battery cell 200 may be a lithium-ion battery. In some embodiments, the lithium-ion battery may include lithium-ion battery chemistries such as a nickel cobalt aluminum (NCA), nickel manganese cobalt (NMC), lithium iron phosphate (LiFePO4), lithium cobalt oxide (LCO), and/or lithium manganese oxide (LMO). Persons skilled in the art, upon reviewing the entirety of this disclosure, will be aware of various devices of components that may be used as a battery cell.

In another embodiment, and still referring to FIG. 2, battery cell 200 may store electrical energy in the form of voltage. In some embodiments, battery cell 200 may include a cathode. In some embodiments, the cathode may include a copper current collector. In other embodiments, the cathode may include and/or be composed entirely or in part of a graphite active material. In yet another embodiment, the cathode may include and/or be composed entirely or in part of a binder such as carboxymethyl cellulose and styrene butadiene rubber. In still another embodiment, the cathode may include and/or be composed entirely or in part of a conductive carbon. In some embodiments, the cathode may be configured to collect electrons in the form of current. In some embodiments, the electrodes may include an anode. The anode may include and/or be composed entirely or in part of an aluminum foil current collector. In another embodiment, the anode may include and/or be composed entirely or in part of a metal oxide active material. In other embodiments, the anode may include and/or be composed entirely or in part of a binder such as polyvinylidene fluoride. In one embodiment, the anode may be a conductive carbon. In some embodiments, the anode of battery cell 200 may be configured to deliver electrons to an external load in the form of current.

Energy density, as used herein, is defined as the amount of energy stored in a given system or region of space per unit volume and colloquially, energy per unit mass (also known as “specific energy”), the units of which may be presented in Joules per kilogram (J/kg), kilocalories per gram (kcal/g), British Thermal Units per pound mass (BTU/lb), and in SI base units, meters squared per seconds squared (m²/s²), and for the purposes of this disclosure Watt hours per kilogram (Wh/kg). In some embodiments, and with further reference to FIG. 2, the energy density of battery cell 200 may be 150 Wh/kg. In some embodiments, the energy density of battery cell 200 may be greater than or less than 150 Wh/kg. In some embodiments, battery cell 200 may have a cell dimension of 140 mm by 8.5 mm by 240 mm. In other embodiments, battery cell 200 may have a cell dimension greater than or less than 140 mm by 8.6 mm by 240 mm. In some embodiments, battery cell 200 may have a voltage rating of between 1 and 10 volts. In one embodiment, battery cell 200 may have a voltage rating of 3.2 volts. In other embodiments, battery cell 200 may have a voltage rating of over 10 volts. In some embodiments, battery cell 200 may have a capacity of between 1 and 100 Ah. In one embodiment, the battery cell 200 may have a capacity of 25 Ah. In some embodiments, battery cell 200 may have a weight over 50 grams. In one embodiment, battery cell 200 may have a weight of less than 50 grams. In one embodiment, the battery cell 200 may have a weight of 530 grams.

Referring still to FIG. 2, in some embodiments, battery cell 200 may be a lithium-ion pouch cell. Battery cell 200 may include electrodes. The electrodes may include a positive electrode and a negative electrode. Each electrode of may include an electrically conductive element. Non-limiting exemplary electrically conductive elements include braided wire, solid wire, metallic foil, circuitry, such as printed circuit boards, and the like. The electrodes may be in electric communication with a pair of foil tabs 202A-B. The electrodes may be bonded in electric communication with pair of foil tabs 202A-B by any known method, including without limitation welding, brazing, soldering, adhering, engineering fits, electrical connectors, and the like. In some cases, pair of foil tabs 202A-B may include a cathode and an anode. In some cases, an exemplary cathode may include a lithium-based substance, such as lithium-metal oxide, bonded to an aluminum foil tab. In some cases, an exemplary anode may include a carbon-based substance, such as graphite, bonded to a copper tab. In some embodiments, the anode may be double sided. In some embodiments, the cathode may be double sided. In some embodiments, the anode and the cathode may be stacked and wrapped in a separator. In some embodiments, the anode, cathode, and separator may be stacked and wrapped in a z-fold pattern. In other embodiments, the anode, cathode, and separator may be stacked and wrapped in a rectangular, square, or other pattern. In some embodiments, the cathode and the anode may be welded together, placing them in a series connection. In one embodiment, the cathode and anode may be welded ultrasonically. In some embodiments, the cathode and the anode may be further welded to pair of foil tabs 202A-B.

The pair of foil tabs 202A-B may be sealed to an outside section of the battery cell 200. In some embodiments, pair of foil tabs 202A-B may be configured to connect to an external load or power source. In some embodiments, pair of foil tabs 202A-B may be configured to power an electric aircraft. In some embodiments, the electric aircraft may be an electric vertical takeoff and landing vehicle (“eVTOL”). In some embodiments, battery cell 200 may have a separator. In some embodiments, the separator may be an insulation layer. As used in this disclosure, an “insulator layer” is an electrically insulating material that is substantially permeable to battery ions, such as without limitation lithium ions. In some cases, insulator layer may be referred to as a separator layer or simply separator. In some cases, the separator may be configured to prevent electrical communication directly between pair of foil tabs 202A-B (e.g., cathode and anode). In some cases, the separator may be configured to allow for a flow ions across it. The separator may consist of a polymer, for example polyolifine (PO). The separator may comprise pours which are configured to allow for passage of ions, for example lithium ions. In some cases, pours of a PO separator may have a width no greater than 100 μm, 10 μm, 1 μm, or 0.1 μm. In some cases, a PO separator may have a thickness within a range of 1-100 μm, or 10-50 μm. Battery cell 200 may include an electrolyte. The electrolyte may be located within battery cell 200. In some cases, electrolyte may comprise a liquid, a solid, a gel, a paste, and/or a polymer. In some embodiments, the electrolyte may be a lithium salt such as LiPF6. In some embodiments, the lithium salt may be lithium hexafluorophosphate, lithium tetrafluoroborate, lithium perchlorate, or other lithium salts. In some embodiments, the lithium salt may be in an organic solvent. In some embodiments, the organic solvent may be ethylene carbonate, dimethyl carbonate, diethyl carbonate or other organic solvents. The electrolyte may wet or contact one or both of at least a pair of foil tabs.

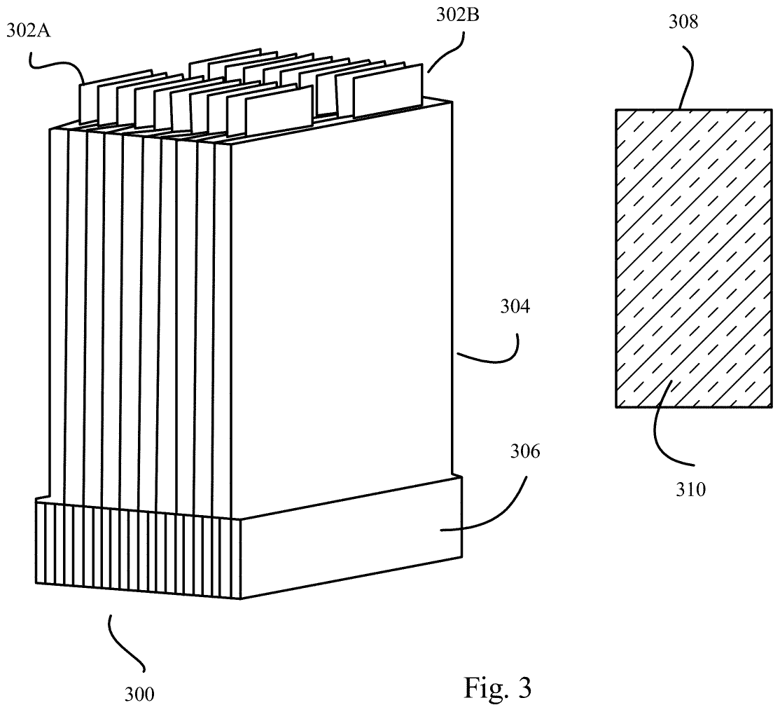

Referring now to FIG. 3, an illustration of an exemplary embodiment of a battery pack 300 adjacent to a barrier 308 is shown. In some embodiments, battery pack 300 may include lithium-ion battery cells 304. In some embodiments, battery cells 304 may be pouch cells. In some embodiments, battery cell 300 may include foil tabs 302A-B. In some embodiments, foil tabs 302A-B may be electrically connected to electrodes located inside a battery cell 304. In some embodiments, conductive foil tabs 302A-B may be sealed to an outside section of battery cell 304. Battery cells 304 in battery pack 300 may be electrically configured to connect to one another. In one embodiment, battery cells 304 of battery pack 300 may have an insulating barrier. In some embodiments, battery cells 304 of battery pack 300 may be configured in series and/or in parallel. In some embodiments, battery cells 304 may be positioned in one row in battery pack 300. In other embodiments, battery cells 304 may be positioned in multiple rows in the battery pack 300. In some embodiments, battery cells 304 may be in a staggered arrangement in battery pack 300.

In some embodiments, barrier 308 may be in the form of a sheet. In some embodiments, barrier 308 may be in the form of a flexible sheet. In other embodiments, barrier 308 may be in the form of a rigid sheet. In some embodiments, barrier 308 may be made from a polymer 310. In some embodiments, barrier 308 may be made from carbon fiber. In some embodiments, barrier 308 may be a carbon fiber sheet. In some embodiments, barrier 308 may be constructed from carbon filaments formed from a polymer 310. Polymer 310 may be polyacrylonitrile, rayon, petroleum pitch, or other polymers. Polymer 310 may be spun into filament yarns. In one embodiment, polymer 310 may be fabricated using chemical and/or mechanical processes to align polymer molecules in a way that enhances the physical properties of the polymer. In one embodiment, polymer 310 may be heated to 200 C or more. In one embodiment, polymer 310 may be heated at 300 C. This may break hydrogen bonds in polymer 310 as well as oxidizing polymer 310. Polymer 310 may be placed into a furnace having an inert gas such as argon. The furnace may be heated to about 2000 C. In some embodiments, the furnace may be heated to more or less than 2000 C. Polymer 310 may become graphitized. In one embodiment, polymer 310 may include ladder polymers which may form narrow graphene sheets. The graphene sheets may merge to form a single columnar filament. In some embodiments, the graphene sheets may merge to form a plurality of columnar filaments. In some embodiment, polymer 310 may be heated further, which may increase the tensile strength of polymer 310. In some embodiments, polymer 310 can be heated in a range of 1500 C to 2000 C. In some embodiments, polymer 310 can be heated above or below a range of 1500 C to 2000 C.

In some embodiments, and still referring to FIG. 3, barrier 308 may be a rectangular, ovular, square, or non-regular shape. In some embodiments, barrier 308 may have carbon fibers which may be between 5 to 10 micrometers in diameter. In other embodiments, barrier 308 may have carbon fibers which may be greater than 10 micrometers or smaller than 5 micrometers in diameter. In some embodiments, barrier 308 may have a larger surface area than battery pack 300. In some embodiments, barrier 308 may have a smaller surface area than the battery cell 300. In some embodiments, barrier 308 may be folded. In some embodiments, barrier 308 may be folded around a battery cell 304. In some embodiments, barrier 308 may be secured to an outside portion of battery pack 300. In one embodiment, barrier 308 may be positioned at a group of seams of a battery pack 300. In other embodiments, barrier 308 may be positioned next to and separately from battery pack 300. In some embodiments, barrier 308 may be positioned around a battery cell 304. In some embodiments, barrier 308 may replace conventional insulating barriers in a battery pack 300. In some embodiments, barrier 308 may be configured to reduce the thermal transfer between two or more battery cells 304. Barrier 308 may be configured to catch lithium ejecta from a battery cell 304. In some embodiments, barrier 308 may filter lithium ejecta from a battery cell 304 from ambient airflow.

As used in this disclosure, “ejecta” is any material that has been ejected, for example from a battery cell. In some cases, ejecta may be ejected during thermal runaway of a battery cell. Alternatively or additionally, in some cases, eject may be ejected without thermal runaway of a battery cell. In some cases, ejecta may include lithium-based compounds. Alternatively or additionally, ejecta may include carbon-based compounds, such as without limitation carbonate esters. Ejecta may include matter in any phase or form, including solid, liquid, gas, vapor, and the like. In some cases, ejecta may undergo a phase change, for example ejecta may be vaporous as it is initially being ejected and then cool and condense into a solid or liquid after ejection.

With continued reference to FIG. 3, in some embodiments, barrier 308 may be in the form of an epoxy. In some embodiments, barrier 308 may be in the form of a foam. In some embodiments, barrier 308 may be made from a polymer foam. In one embodiment, barrier 308 may be made from a carbon fiber foam. In some embodiments, barrier 308 may be in the form of a gel. In some embodiments, barrier 308 may be a carbon fiber gel. In some embodiments, barrier 308 may be positioned in a corner of battery pack 300. In other embodiments, the barrier 308 may be positioned in a corner of battery cell 304. In some embodiments, multiple barriers may be positioned in multiple corners of battery pack 300. In some embodiments, multiple barriers may be positioned in multiple corners of a battery cell 304. In some embodiments, barrier 308 may include a polymer mesh having a hexagonal, rectangular, grid, or other pattern. In some embodiments, barrier 308 may filter lithium ejecta from the surrounding air of battery cell 304. In some embodiments, barrier 308 may be lightweight and therefore may improve the energy density of battery pack 300. In some embodiments, barrier 308 may be positioned around a pouch of battery cell 304. In some embodiments, barrier 308 may be configured to prevent a swelling of a pouch of battery cell 304. In some embodiments, barrier 308 may provide structural support to battery cell 304. In some embodiments, barrier 308 may provide structural support to battery pack 300.

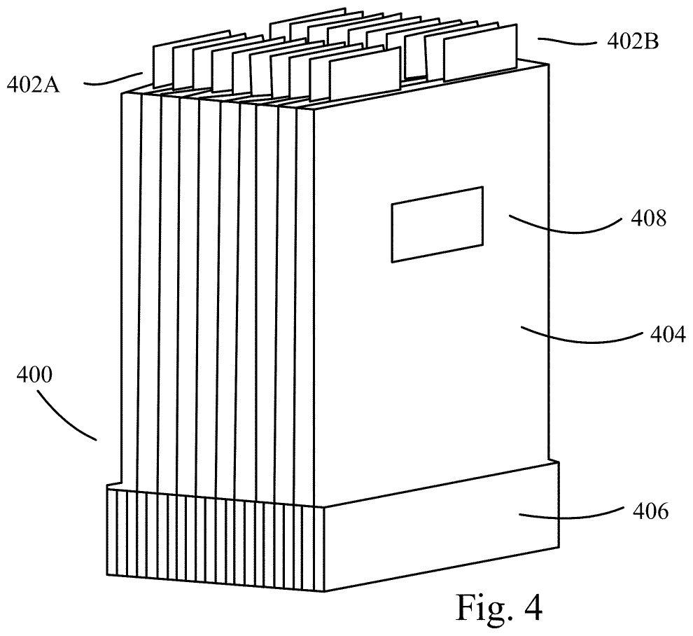

Referring now to FIG. 4, an illustration of an exemplary embodiment of a sense board 408 connected to a battery pack 400 is shown. In some embodiments, sense board 408 includes a moisture sensor. “Moisture”, as used in this disclosure, is the presence of water, this may include vaporized water in air, condensation on the surfaces of objects, or concentrations of liquid water. Moisture may include humidity. “Humidity”, as used in this disclosure, is the property of a gaseous medium (almost always air) to hold water in the form of vapor. An amount of water vapor contained within a parcel of air can vary significantly. Water vapor is generally invisible to the human eye and may be damaging to electrical components. There are three primary measurements of humidity, absolute, relative, specific humidity. “Absolute humidity,” for the purposes of this disclosure, describes the water content of air and is expressed in either grams per cubic meters or grams per kilogram. “Relative humidity”, for the purposes of this disclosure, is expressed as a percentage, indicating a present stat of absolute humidity relative to a maximum humidity given the same temperature. “Specific humidity”, for the purposes of this disclosure, is the ratio of water vapor mass to total moist air parcel mass, where parcel is a given portion of a gaseous medium. The moisture sensor may be psychrometer. The moisture sensor may be a hygrometer. The moisture sensor may be configured to act as or include a humidistat. A “humidistat”, for the purposes of this disclosure, is a humidity-triggered switch, often used to control another electronic device. The moisture sensor may use capacitance to measure relative humidity and include in itself, or as an external component, include a device to convert relative humidity measurements to absolute humidity measurements. “Capacitance”, for the purposes of this disclosure, is the ability of a system to store an electric charge, in this case the system is a parcel of air which may be near, adjacent to, or above a battery cell.

With continued reference to FIG. 4, sense board 408 may include electrical sensors. Electrical sensors may be configured to measure voltage across a component, electrical current through a component, and resistance of a component. Electrical sensors may include separate sensors to measure each of the previously disclosed electrical characteristics such as voltmeter, ammeter, and ohmmeter, respectively.

Alternatively or additionally, and with continued reference to FIG. 4, sensor board 408 include a sensor or plurality thereof that may detect voltage and direct the charging of individual battery cells according to charge level; detection may be performed using any suitable component, set of components, and/or mechanism for direct or indirect measurement and/or detection of voltage levels, including without limitation comparators, analog to digital converters, any form of voltmeter, or the like. Sense board and/or a control circuit incorporated therein and/or communicatively connected thereto may be configured to adjust charge to one or more battery cells as a function of a charge level and/or a detected parameter. For instance, and without limitation, sensor board 408 may be configured to determine that a charge level of a battery cell 404 is high based on a detected voltage level of that battery cell or portion of the battery pack. Sense board 408 may alternatively or additionally detect a charge reduction event, defined for purposes of this disclosure as any temporary or permanent state of a battery cell requiring reduction or cessation of charging; a charge reduction event may include a cell being fully charged and/or a cell undergoing a physical and/or electrical process that makes continued charging at a current voltage and/or current level inadvisable due to a risk that the cell will be damaged, will overheat, or the like. Detection of a charge reduction event may include detection of a temperature, of the cell above a threshold level, detection of a voltage and/or resistance level above or below a threshold, or the like. Sense board 408 may include digital sensors, analog sensors, or a combination thereof. Sense board 408 may include digital-to-analog converters (DAC), analog-to-digital converters (ADC, A/D, A-to-D), a combination thereof, or other signal conditioning components used in transmission of a plurality of battery pack data 408 to a destination over wireless or wired connection.

With continued reference to FIG. 4, sense board 408 may include thermocouples, thermistors, thermometers, passive infrared sensors, resistance temperature sensors (RTD's), semiconductor based integrated circuits (IC), a combination thereof or another undisclosed sensor type, alone or in combination. Temperature, for the purposes of this disclosure, and as would be appreciated by someone of ordinary skill in the art, is a measure of the heat energy of a system. Temperature, as measured by any number or combinations of sensors present within sensor suite 500, may be measured in Fahrenheit (° F.), Celsius (° C.), Kelvin (° K), or another scale alone or in combination. The temperature measured by sensors may comprise electrical signals which are transmitted to their appropriate destination wireless or through a wired connection.

With continued reference to FIG. 4, sense board 408 may include a sensor configured to detect gas that may be emitted during or after a cell failure. “Cell failure”, for the purposes of this disclosure, refers to a malfunction of a battery cell, which may be an electrochemical cell, that renders the cell inoperable for its designed function, namely providing electrical energy to at least a portion of an electric aircraft. Byproducts of cell failure may include gaseous discharge including oxygen, hydrogen, carbon dioxide, methane, carbon monoxide, a combination thereof, or another undisclosed gas, alone or in combination. Further the sensor configured to detect vent gas from electrochemical cells may comprise a gas detector. For the purposes of this disclosure, a “gas detector” is a device used to detect a gas is present in an area. Gas detectors, and more specifically, the gas sensor that may be used in sense board 408, may be configured to detect combustible, flammable, toxic, oxygen depleted, a combination thereof, or another type of gas alone or in combination. The gas sensor that may be present in sense board 408 may include a combustible gas, photoionization detectors, electrochemical gas sensors, ultrasonic sensors, metal-oxide-semiconductor (MOS) sensors, infrared imaging sensors, a combination thereof, or another undisclosed type of gas sensor alone or in combination. Sense board 408 may include sensors that are configured to detect non-gaseous byproducts of cell failure including, in non-limiting examples, liquid chemical leaks including aqueous alkaline solution, ionomer, molten phosphoric acid, liquid electrolytes with redox shuttle and ionomer, and salt water, among others. Sense board 408 may include sensors that are configured to detect non-gaseous byproducts of cell failure including, in non-limiting examples, electrical anomalies as detected by any of the previous disclosed sensors or components.

With continued reference to FIG. 4, sense board 408 may be configured to detect events where voltage nears an upper voltage threshold or lower voltage threshold. The upper voltage threshold may be stored in a data storage system for comparison with an instant measurement taken by any combination of sensors present within sense board 408. The upper voltage threshold may be calculated and calibrated based on factors relating to battery cell health, maintenance history, location within battery pack, designed application, and type, among others. Sense board 408 may measure voltage at an instant, over a period of time, or periodically. Sense board 408 may be configured to operate at any of these detection modes, switch between modes, or simultaneous measure in more than one mode. Sense board 408 may detect through a sensor events where voltage nears the lower voltage threshold. The lower voltage threshold may indicate power loss to or from an individual battery cell or portion of the battery pack. Sense board 408 may detect through a sensor events where voltage exceeds the upper and lower voltage threshold. Events where voltage exceeds the upper and lower voltage threshold may indicate battery cell failure or electrical anomalies that could lead to potentially dangerous situations for aircraft and personnel that may be present in or near its operation.

In some embodiments, sense board 408 may be integrated into a battery cell 404. In some embodiments, sense board 408 may be integrated into the cell retainer 406. In some embodiments, a plurality of sense boards may be integrated to battery pack 400. In some embodiments, sense board 408 may sense a characteristic as an analog measurement, for instance, yielding a continuously variable electrical potential indicative of the sensed characteristic. In these cases, sense board 408 may additionally comprise an analog to digital converter (ADC) as well as any additionally circuitry, such as without limitation a Whetstone bridge, an amplifier, a filter, and the like. The herein disclosed system and method may comprise a plurality of sensors in the form of individual sensors or a sensor suite working in tandem or individually. A sensor suite may include a plurality of independent sensors, as described herein, where any number of the described sensors may be used to detect any number of physical or electrical quantities associated with an aircraft power system or an electrical energy storage system. Independent sensors may include separate sensors measuring physical or electrical quantities that may be powered by and/or in communication with circuits independently, where each may signal sensor output to a control circuit such as a user graphical interface. In a non-limiting example, there may be four independent sensors housed in and/or on battery pack 400 measuring temperature, electrical characteristic such as voltage, amperage, resistance, or impedance, or any other parameters and/or quantities as described in this disclosure.

In some embodiments, the sense board 408 may have sensors configured to measure the temperature of battery cell 404. In some embodiments, sense board 408 may have one or more resistance thermometers. Sense board 408 may include, without limitation, a resistance temperature detector, thermocouple, thermistor, thermometer, or other type of temperature sensor. Sense board 408 may include a sensing element that may be made from a metal whose electric resistance increases with increasing temperature. In some embodiments, sense board 408 may include a metal with an electric resistance that quadratically increases with increasing temperature. Sense board 408 may include a negative temperature coefficient (“NTC”) thermistor. The NTC thermistor may have a resistance that may decrease with increasing temperature. In some embodiments, the NTC thermistor may be a bead, disk, chip, glass encapsulated, or other NTC thermistor. In some embodiments, sense board 408 may include platinum, nickel, copper, palladium, indium, germanium, or other elements. Sense board 306 may include one or more sensing wires. In some embodiments, the sensing wires may be made from a metal. In some embodiments, sense board 408 may have a sensing wire that may be 0.05 mm thick. In other embodiments, sense board 408 may have a sensing wire that may be greater or less than 0.05 mm thick. In some embodiments, the sense board 408 may be secured to a single side of battery cell 404. In some embodiments, sense board 408 may be secured to two or more sides of battery cell 404. In some embodiments, sense board 408 may be configured to relay temperature data to an external computing device. In some embodiments, sense board 408 may be configured to relay temperature data to an external computing device wirelessly. In other embodiments, sense board 408 may be configured to relay temperature data to an external computing device via a wired connection.

In some embodiments, and still referring to FIG. 4, sense board 408 may include one or more circuits and/or circuit elements, including without limitation a printed circuit board component, aligned with a first side of battery cell 404. Sense board 408 may include, without limitation, a control circuit, which may include any analog or digital control circuit, including without limitation a combinational and/or synchronous logic circuit, a processor, microprocessor, microcontroller, or the like. Sense board 408 may include other sensors configured to measure physical and/or electrical parameters, such as without limitation temperature and/or voltage, of one or more battery cells. Sense board 408 and/or a control circuit incorporated therein and/or communicatively connected thereto, may further be configured to detect failure within each battery cell 404, for instance and without limitation as a function of and/or using detected physical and/or electrical parameters. Cell failure may be characterized by a spike in temperature. Sense board 408 may be configured to detect the spike in temperature and generate signals, which are discussed further below, to notify users, support personnel, safety personnel, maintainers, operators, emergency personnel, aircraft computers, or a combination thereof. Sense board 408 may include passive infrared sensors, resistance temperature sensors (RTD's), semiconductor based integrated circuits (IC), a combination thereof or another undisclosed sensor type, alone or in combination. Temperature, for the purposes of this disclosure, and as would be appreciated by someone of ordinary skill in the art, is a measure of the heat energy of a system. Heat energy is, at its core, the measure of kinetic energy of matter present within a system. Temperature, as measured by any number or combinations of sensors present on sense board 408, may be measured in Fahrenheit (° F.), Celsius (° C.), Kelvin (° K), or another scale alone or in combination. The temperature measured by sensors may comprise electrical signals which are transmitted to their appropriate destination wireless or through a wired connection.

Alternatively or additionally, and with continued reference to FIG. 4, sense board 408 may detect voltage and direct the charging of individual battery cells according to charge level; detection may be performed using any suitable component, set of components, and/or mechanism for direct or indirect measurement and/or detection of voltage levels, including without limitation comparators, analog to digital converters, any form of voltmeter, or the like.

With continued reference to FIG. 4, sense board 408 and/or a control circuit incorporated therein and/or communicatively connected thereto may be configured to adjust charge to one or more battery cells as a function of a charge level and/or a detected parameter. For instance, and without limitation, sense board 408 may be configured to determine that a charge level of a battery cell is high based on a detected voltage level of that battery cell. Sense board 408 may alternatively or additionally detect a charge reduction event, defined for purposes of this disclosure as any temporary or permanent state of a battery cell requiring reduction or cessation of charging; a charge reduction event may include a cell being fully charged and/or a cell undergoing a physical and/or electrical process that makes continued charging at a current voltage and/or current level inadvisable due to a risk that the cell will be damaged, will overheat, or the like. Detection of a charge reduction event may include detection of a temperature, of the cell above a threshold level, detection of a voltage and/or resistance level above or below a threshold, or the like. In some embodiments, the sense board 408 may be configured to detect swelling of a pouch of a battery cell 404.

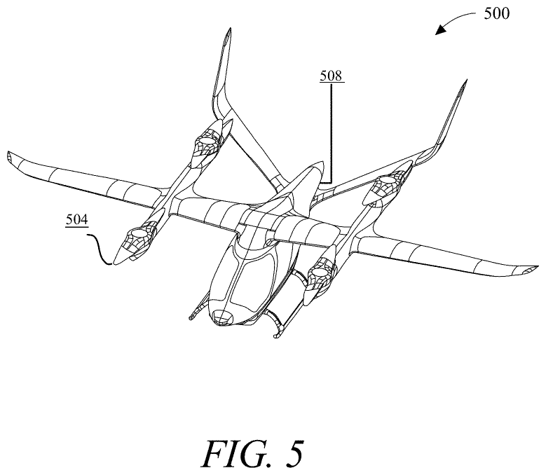

Referring now to FIG. 5, an illustration of an exemplary embodiment of an electric aircraft 400 is shown. Battery pack 400 as described above may power at least a portion of the electric aircraft 500. In some embodiments, battery pack 400 may be positioned inside the electric aircraft 500. Electric aircraft 500 may include a vertical takeoff and landing aircraft (eVTOL). As used herein, a vertical take-off and landing (eVTOL) aircraft is one that may hover, take off, and land vertically. An eVTOL, as used herein, is an electrically powered aircraft typically using an energy source, of a plurality of energy sources to power the aircraft. In order to optimize the power and energy necessary to propel the aircraft. eVTOL may be capable of rotor-based cruising flight, rotor-based takeoff, rotor-based landing, fixed-wing cruising flight, airplane-style takeoff, airplane-style landing, and/or any combination thereof. Rotor-based flight, as described herein, is where the aircraft generated lift and propulsion by way of one or more powered rotors coupled with an engine, such as a “quad copter,” multi-rotor helicopter, or other vehicle that maintains its lift primarily using downward thrusting propulsors. Fixed-wing flight, as described herein, is where the aircraft is capable of flight using wings and/or foils that generate life caused by the aircraft's forward airspeed and the shape of the wings and/or foils, such as airplane-style flight.

With continued reference to FIG. 5, a number of aerodynamic forces may act upon the electric aircraft 500 during flight. Forces acting on an electric aircraft 500 during flight may include, without limitation, thrust, the forward force produced by the rotating element of the electric aircraft 500 and acts parallel to the longitudinal axis. Another force acting upon electric aircraft 500 may be, without limitation, drag, which may be defined as a rearward retarding force which is caused by disruption of airflow by any protruding surface of the electric aircraft 500 such as, without limitation, the wing, rotor, and fuselage. Drag may oppose thrust and acts rearward parallel to the relative wind. A further force acting upon electric aircraft 500 may include, without limitation, weight, which may include a combined load of the electric aircraft 500 itself, crew, baggage, and/or fuel. Weight may pull electric aircraft 500 downward due to the force of gravity. An additional force acting on electric aircraft 500 may include, without limitation, lift, which may act to oppose the downward force of weight and may be produced by the dynamic effect of air acting on the airfoil and/or downward thrust from the propulsor of the electric aircraft. Lift generated by the airfoil may depend on speed of airflow, density of air, total area of an airfoil and/or segment thereof, and/or an angle of attack between air and the airfoil. For example, and without limitation, electric aircraft 500 are designed to be as lightweight as possible. Reducing the weight of the aircraft and designing to reduce the number of components is essential to optimize the weight. To save energy, it may be useful to reduce weight of components of an electric aircraft 500, including without limitation propulsors and/or propulsion assemblies. In an embodiment, the motor may eliminate need for many external structural features that otherwise might be needed to join one component to another component. The motor may also increase energy efficiency by enabling a lower physical propulsor profile, reducing drag and/or wind resistance. This may also increase durability by lessening the extent to which drag and/or wind resistance add to forces acting on electric aircraft 500 and/or propulsors.

Referring still to FIG. 5, Aircraft may include at least a vertical propulsor 504 and at least a forward propulsor 508. A forward propulsor is a propulsor that propels the aircraft in a forward direction. Forward in this context is not an indication of the propulsor position on the aircraft; one or more propulsors mounted on the front, on the wings, at the rear, etc. A vertical propulsor is a propulsor that propels the aircraft in an upward direction; one of more vertical propulsors may be mounted on the front, on the wings, at the rear, and/or any suitable location. A propulsor, as used herein, is a component or device used to propel a craft by exerting force on a fluid medium, which may include a gaseous medium such as air or a liquid medium such as water. At least a vertical propulsor 504 is a propulsor that generates a substantially downward thrust, tending to propel an aircraft in a vertical direction providing thrust for maneuvers such as without limitation, vertical take-off, vertical landing, hovering, and/or rotor-based flight such as “quadcopter” or similar styles of flight.

With continued reference to FIG. 5, at least a forward propulsor 508 as used in this disclosure is a propulsor positioned for propelling an aircraft in a “forward” direction; at least a forward propulsor may include one or more propulsors mounted on the front, on the wings, at the rear, or a combination of any such positions. At least a forward propulsor may propel an aircraft forward for fixed-wing and/or “airplane”-style flight, takeoff, and/or landing, and/or may propel the aircraft forward or backward on the ground. At least a vertical propulsor 504 and at least a forward propulsor 508 includes a thrust element. At least a thrust element may include any device or component that converts the mechanical energy of a motor, for instance in the form of rotational motion of a shaft, into thrust in a fluid medium. At least a thrust element may include, without limitation, a device using moving or rotating foils, including without limitation one or more rotors, an airscrew or propeller, a set of airscrews or propellers such as contrarotating propellers, a moving or flapping wing, or the like. At least a thrust element may include without limitation a marine propeller or screw, an impeller, a turbine, a pump-jet, a paddle or paddle-based device, or the like. As another non-limiting example, at least a thrust element may include an eight-bladed pusher propeller, such as an eight-bladed propeller mounted behind the engine to ensure the drive shaft is in compression. Propulsors may include at least a motor mechanically coupled to the at least a first propulsor as a source of thrust. A motor may include without limitation, any electric motor, where an electric motor is a device that converts electrical energy into mechanical energy, for instance by causing a shaft to rotate. At least a motor may be driven by direct current (DC) electric power; for instance, at least a first motor may include a brushed DC at least a first motor, or the like. At least a first motor may be driven by electric power having varying or reversing voltage levels, such as alternating current (AC) power as produced by an alternating current generator and/or inverter, or otherwise varying power, such as produced by a switching power source. At least a first motor may include, without limitation, brushless DC electric motors, permanent magnet synchronous at least a first motor, switched reluctance motors, or induction motors. In addition to inverter and/or a switching power source, a circuit driving at least a first motor may include electronic speed controllers or other components for regulating motor speed, rotation direction, and/or dynamic braking. Persons skilled in the art, upon reviewing the entirety of this disclosure, will be aware of various devices that may be used as at least a thrust element.

With continued reference to FIG. 5, during flight, a number of forces may act upon the electric aircraft. Forces acting on an aircraft 500 during flight may include thrust, the forward force produced by the rotating element of the aircraft 500 and acts parallel to the longitudinal axis. Drag may be defined as a rearward retarding force which is caused by disruption of airflow by any protruding surface of the aircraft 500 such as, without limitation, the wing, rotor, and fuselage. Drag may oppose thrust and acts rearward parallel to the relative wind. Another force acting on aircraft 500 may include weight, which may include a combined load of the aircraft 500 itself, crew, baggage and fuel. Weight may pull aircraft 500 downward due to the force of gravity. An additional force acting on aircraft 500 may include lift, which may act to oppose the downward force of weight and may be produced by the dynamic effect of air acting on the airfoil and/or downward thrust from at least a propulsor. Lift generated by the airfoil may depends on speed of airflow, density of air, total area of an airfoil and/or segment thereof, and/or an angle of attack between air and the airfoil.

It is to be noted that any one or more of the aspects and embodiments described herein may be conveniently implemented using one or more machines (e.g., one or more computing devices that are utilized as a user computing device for an electronic document, one or more server devices, such as a document server, etc.) programmed according to the teachings of the present specification, as will be apparent to those of ordinary skill in the computer art. Appropriate software coding can readily be prepared by skilled programmers based on the teachings of the present disclosure, as will be apparent to those of ordinary skill in the software art. Aspects and implementations discussed above employing software and/or software modules may also include appropriate hardware for assisting in the implementation of the machine executable instructions of the software and/or software module.

Such software may be a computer program product that employs a machine-readable storage medium. A machine-readable storage medium may be any medium that is capable of storing and/or encoding a sequence of instructions for execution by a machine (e.g., a computing device) and that causes the machine to perform any one of the methodologies and/or embodiments described herein. Examples of a machine-readable storage medium include, but are not limited to, a magnetic disk, an optical disc (e.g., CD, CD-R, DVD, DVD-R, etc.), a magneto-optical disk, a read-only memory “ROM” device, a random access memory “RAM” device, a magnetic card, an optical card, a solid-state memory device, an EPROM, an EEPROM, and any combinations thereof. A machine-readable medium, as used herein, is intended to include a single medium as well as a collection of physically separate media, such as, for example, a collection of compact discs or one or more hard disk drives in combination with a computer memory. As used herein, a machine-readable storage medium does not include transitory forms of signal transmission.

Such software may also include information (e.g., data) carried as a data signal on a data carrier, such as a carrier wave. For example, machine-executable information may be included as a data-carrying signal embodied in a data carrier in which the signal encodes a sequence of instruction, or portion thereof, for execution by a machine (e.g., a computing device) and any related information (e.g., data structures and data) that causes the machine to perform any one of the methodologies and/or embodiments described herein.

Examples of a computing device include, but are not limited to, an electronic book reading device, a computer workstation, a terminal computer, a server computer, a handheld device (e.g., a tablet computer, a smartphone, etc.), a web appliance, a network router, a network switch, a network bridge, any machine capable of executing a sequence of instructions that specify an action to be taken by that machine, and any combinations thereof. In one example, a computing device may include and/or be included in a kiosk.

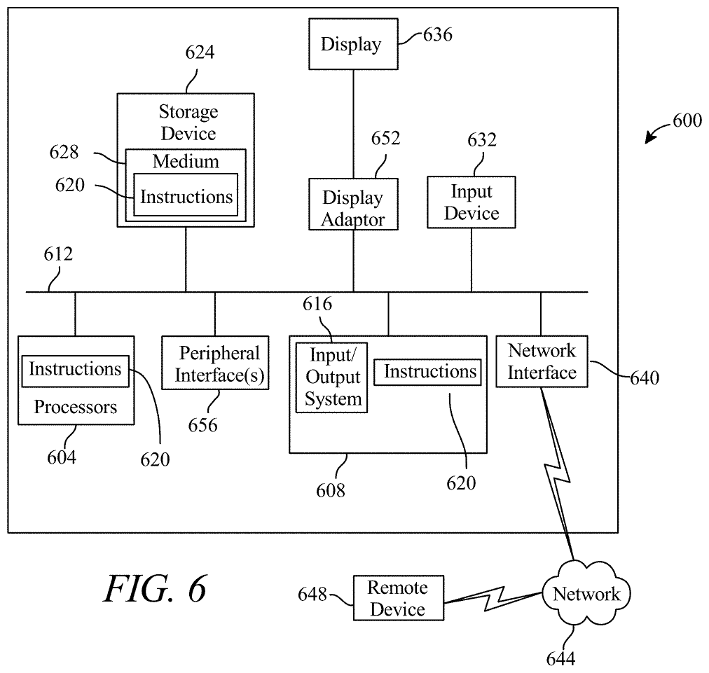

FIG. 6 shows a diagrammatic representation of one embodiment of a computing device in the exemplary form of a computer system 600 within which a set of instructions for causing a control system to perform any one or more of the aspects and/or methodologies of the present disclosure may be executed. It is also contemplated that multiple computing devices may be utilized to implement a specially configured set of instructions for causing one or more of the devices to perform any one or more of the aspects and/or methodologies of the present disclosure. Computer system 600 includes a processor 604 and a memory 608 that communicate with each other, and with other components, via a bus 612. Bus 612 may include any of several types of bus structures including, but not limited to, a memory bus, a memory controller, a peripheral bus, a local bus, and any combinations thereof, using any of a variety of bus architectures.

Processor 604 may include any suitable processor, such as without limitation a processor incorporating logical circuitry for performing arithmetic and logical operations, such as an arithmetic and logic unit (ALU), which may be regulated with a state machine and directed by operational inputs from memory and/or sensors; processor 604 may be organized according to Von Neumann and/or Harvard architecture as a non-limiting example. Processor 604 may include, incorporate, and/or be incorporated in, without limitation, a microcontroller, microprocessor, digital signal processor (DSP), Field Programmable Gate Array (FPGA), Complex Programmable Logic Device (CPLD), Graphical Processing Unit (GPU), general purpose GPU, Tensor Processing Unit (TPU), analog or mixed signal processor, Trusted Platform Module (TPM), a floating point unit (FPU), and/or system on a chip (SoC).

Memory 608 may include various components (e.g., machine-readable media) including, but not limited to, a random-access memory component, a read only component, and any combinations thereof. In one example, a basic input/output system 616 (BIOS), including basic routines that help to transfer information between elements within computer system 600, such as during start-up, may be stored in memory 608. Memory 608 may also include (e.g., stored on one or more machine-readable media) instructions (e.g., software) 620 embodying any one or more of the aspects and/or methodologies of the present disclosure. In another example, memory 608 may further include any number of program modules including, but not limited to, an operating system, one or more application programs, other program modules, program data, and any combinations thereof.

Computer system 600 may also include a storage device 624. Examples of a storage device (e.g., storage device 624) include, but are not limited to, a hard disk drive, a magnetic disk drive, an optical disc drive in combination with an optical medium, a solid-state memory device, and any combinations thereof. Storage device 624 may be connected to bus 612 by an appropriate interface (not shown). Example interfaces include, but are not limited to, SCSI, advanced technology attachment (ATA), serial ATA, universal serial bus (USB), IEEE 1394 (FIREWIRE), and any combinations thereof. In one example, storage device 624 (or one or more components thereof) may be removably interfaced with computer system 600 (e.g., via an external port connector (not shown)). Particularly, storage device 624 and an associated machine-readable medium 628 may provide nonvolatile and/or volatile storage of machine-readable instructions, data structures, program modules, and/or other data for computer system 600. In one example, software 620 may reside, completely or partially, within machine-readable medium 628. In another example, software 620 may reside, completely or partially, within processor 604.

Computer system 600 may also include an input device 632. In one example, a user of computer system 600 may enter commands and/or other information into computer system 600 via input device 632. Examples of an input device 632 include, but are not limited to, an alpha-numeric input device (e.g., a keyboard), a pointing device, a joystick, a gamepad, an audio input device (e.g., a microphone, a voice response system, etc.), a cursor control device (e.g., a mouse), a touchpad, an optical scanner, a video capture device (e.g., a still camera, a video camera), a touchscreen, and any combinations thereof. Input device 632 may be interfaced to bus 612 via any of a variety of interfaces (not shown) including, but not limited to, a serial interface, a parallel interface, a game port, a USB interface, a FIREWIRE interface, a direct interface to bus 612, and any combinations thereof. Input device 632 may include a touch screen interface that may be a part of or separate from display 636, discussed further below. Input device 632 may be utilized as a user selection device for selecting one or more graphical representations in a graphical interface as described above.

A user may also input commands and/or other information to computer system 600 via storage device 624 (e.g., a removable disk drive, a flash drive, etc.) and/or network interface device 640. A network interface device, such as network interface device 640, may be utilized for connecting computer system 600 to one or more of a variety of networks, such as network 644, and one or more remote devices 648 connected thereto. Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, and any combinations thereof. A network, such as network 644, may employ a wired and/or a wireless mode of communication. In general, any network topology may be used. Information (e.g., data, software 620, etc.) may be communicated to and/or from computer system 600 via network interface device 640.

Computer system 600 may further include a video display adapter 652 for communicating a displayable image to a display device, such as display device 636. Examples of a display device include, but are not limited to, a liquid crystal display (LCD), a cathode ray tube (CRT), a plasma display, a light emitting diode (LED) display, and any combinations thereof. Display adapter 652 and display device 636 may be utilized in combination with processor 604 to provide graphical representations of aspects of the present disclosure. In addition to a display device, computer system 600 may include one or more other peripheral output devices including, but not limited to, an audio speaker, a printer, and any combinations thereof. Such peripheral output devices may be connected to bus 612 via a peripheral interface 656. Examples of a peripheral interface include, but are not limited to, a serial port, a USB connection, a FIREWIRE connection, a parallel connection, and any combinations thereof.

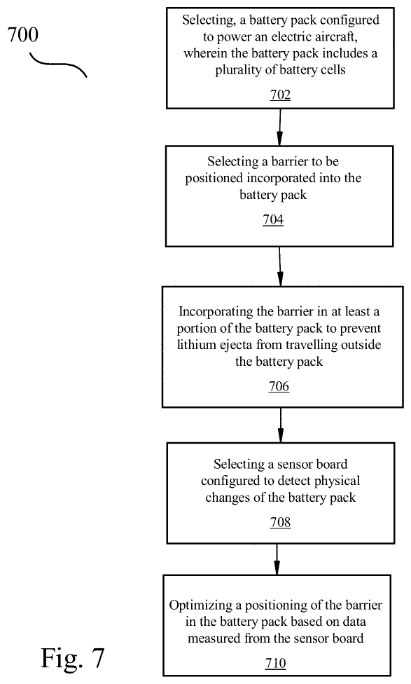

Now referring to FIG. 7, a method 700 for managing a battery pack of an electric aircraft is shown. At step 702, a battery pack is selected. The battery pack may be configured to power an electric vehicle, such as an electric aircraft. In some embodiments, the battery pack may include a plurality of battery cells. The plurality of battery cells may include lithium-ion cells. The plurality of battery cells may include pouch cells. In some embodiments, the battery pack may be selected from a variety of suitable power sources. In some embodiments, the battery pack may be selected based on an energy density.

At step 704, a barrier is selected. The barrier may be selected based on a variety of factors, such as tensile strength, conductivity, weight, or other factors. The barrier may be selected to improve the energy density of the battery pack of an electric aircraft. In some embodiments, the barrier may be pre-manufactured. In other embodiments, the barrier may be manufactured from an injection molding process. The barrier may be selected to include polymers. In some embodiments, the barrier may include carbon fiber. The barrier may be in a sheet form. In some embodiments, the barrier may have a surface area larger than a battery pack. In some embodiments, the barrier may have a surface area smaller than a battery pack. In some embodiments, the barrier may be about the same size as a battery cell in the plurality of battery cells. In other embodiments, the barrier may be larger or smaller than a battery cell in the plurality of battery cells. In some embodiments, the barrier may be porous. The barrier may be flexible. In some embodiments, the barrier may be rigid. The barrier may have a hexagonal pattern of polymers. The barrier may have a rectangular, square, and/or grid pattern of polymers.

At step 706, the barrier is incorporated in at least a portion of the battery pack to prevent lithium ejecta from travelling outside the battery pack. In some embodiments, the barrier may be positioned in a corner of the battery pack. In other embodiments, the barrier may be folded around a battery cell of the battery pack. In other embodiments, the barrier may be positioned around multiple battery cells in the battery pack. In some embodiments, the barrier may be incorporated into a housing of the battery pack. In some embodiments, the barrier may form a housing around one or more battery cells of the battery pack. The barrier may be incorporated into the battery pack as an epoxy. In other embodiments, the barrier may be incorporated into the battery pack as a gel-like substance. In some embodiments, the barrier may be incorporated into the battery pack as a foam-like substance. The barrier may cover at least a portion of a battery cell of the battery pack. The barrier may be incorporated into a group of seams of the battery pack. In some embodiments, the barrier may be incorporated into a lining of a housing of the battery pack. In some embodiments, the incorporation of the barrier may provide structural support to the battery pack and/or the battery cells of the battery pack. In some embodiments, the barrier may be directly contacting one or more battery cells. In other embodiments, the barrier may be positioned at a distance from one or more battery cells. In some embodiments, the barrier may be incorporated into a battery cell retaining structure of the battery pack.

At step 708, a sensor board configured to detect physical changes of the battery pack is selected. In some embodiment, the sensor board may be selected to include a variety of sensors. In some embodiments, the sensor board may be selected to include a thermal sensor. The thermal sensor may include thermocouples, thermistors, thermometers, passive infrared sensors, resistance temperature sensors (RTD's), semiconductor based integrated circuits (IC), a combination thereof or another undisclosed sensor type, alone or in combination. In some embodiments, the sensor board may be configured to detect a change in thermal energy of a battery pack. In other embodiments, the sensor board may be configured to detect voltage levels of the battery pack. In some embodiments, the sensor board may be configured to detect cell failure of a battery cell in the battery pack.

At step 710, the positioning of the barrier in the battery pack is optimized based on data measure from the sensor board. In some embodiments, the sensor board data may show the temperature, voltage, humidity, cell failure, or other measurements of individual cells of the battery pack. In other embodiments, the sensor board may measure the temperature, voltage, humidity, cell failure, or other measurements of the battery pack as a whole. The measurements from the sensor board may provide information on the positioning of the barrier. In some embodiments, the measurements from the sensor board may provide information on the positioning of the barrier in relation to a physical change in the battery pack. In some embodiments, the physical change in the battery pack may be a temperature change. The barrier may be repositioned to improve the thermal energy distribution of the battery pack and/or the battery cells of the battery pack. In some embodiments, the barrier may be positioned in a corner of the battery pack. In other embodiments, the barrier may be placed in a wall of the battery pack. The sensor board may be configured to determine an optimal positioning of the barrier based on the measurements of the battery pack and/or battery cells in the battery pack. The barrier may be placed in a position that would enable it to catch an optimal amount of lithium ejecta of a battery pack.

The foregoing has been a detailed description of illustrative embodiments of the invention. Various modifications and additions can be made without departing from the spirit and scope of this invention. Features of each of the various embodiments described above may be combined with features of other described embodiments as appropriate in order to provide a multiplicity of feature combinations in associated new embodiments. Furthermore, while the foregoing describes a number of separate embodiments, what has been described herein is merely illustrative of the application of the principles of the present invention. Additionally, although particular methods herein may be illustrated and/or described as being performed in a specific order, the ordering is highly variable within ordinary skill to achieve methods, systems, and software according to the present disclosure. Accordingly, this description is meant to be taken only by way of example, and not to otherwise limit the scope of this invention.

Exemplary embodiments have been disclosed above and illustrated in the accompanying drawings. It will be understood by those skilled in the art that various changes, omissions and additions may be made to that which is specifically disclosed herein without departing from the spirit and scope of the present invention.

1. A system for management of a battery pack, comprising:
an electric vertical take-off and landing (eVTOL) aircraft;
a battery pack configured to power and disposed within the eVTOL aircraft, wherein the battery pack includes a plurality of battery cells;
a barrier incorporated in the battery pack, wherein the barrier comprises a flexible polymer that prevents ejecta from at least a battery cell of the plurality of battery cells from traveling outside of the battery pack, wherein the flexible polymer is folded around at least a portion of a battery cell of the battery pack;
a sensor board configured to detect a physical change of the battery pack, the sensor board comprising a gas detector configured to detect a gas emitted from the at least a battery cell of the plurality of battery cells; and
a control circuit communicatively connected to the sensor board, wherein the control circuit is configured to adjust a charge to at least a battery cell of the plurality of battery cells as a function of the detected emitted gas.

2. The system of claim 1, wherein the battery pack includes a flexible casing.

3. The system of claim 1, wherein the plurality of battery cells are pouch cells.

4. The system of claim 1, wherein the plurality of battery cells are lithium-ion cells.

5. The system of claim 1, wherein the barrier comprises a carbon fiber sheet.

6. The system of claim 5, wherein the barrier comprises two or more carbon fiber sheets.

7. The system of claim 1, wherein the barrier is a carbon fiber epoxy.

8. The system of claim 7, wherein the carbon fiber epoxy includes a gel.

9. The system of claim 7, wherein the carbon fiber epoxy includes a foam.

10. The system of claim 1, wherein the barrier positioned in a corner of the battery pack.

11. The system of claim 1, wherein the barrier is positioned at a group of seams of the battery pack.

12. The system of claim 1, wherein the barrier is configured to reduce a thermal energy of the ejecta.

13. The system of claim 1, wherein the sensor board is configured to measure temperature.

14. A method for management of a battery pack, the method comprising:
selecting a battery pack configured to power and disposed within an electric vertical take-off and landing (eVTOL) aircraft, wherein the battery pack includes a plurality of battery cells;
selecting a barrier to be incorporated into the battery pack, wherein the barrier comprises a flexible polymer;
incorporating the barrier in at least a portion of the battery pack to prevent lithium ejecta from travelling outside the battery pack, wherein incorporation further comprises folding the flexible polymer of the barrier around at least a portion of a battery cell of the at least a portion of the battery pack;
selecting a sensor board configured to detect physical changes of the battery pack, the sensor board comprising a gas detector configured to detect a gas emitted from the at least a battery cell of the plurality of battery cells;
optimizing a positioning of the barrier in the battery pack based on data measured from the sensor board; and
adjusting a charge to at least a battery cell of the plurality of battery cells, via a control circuit, as a function of the detected emitted gas.

15. The method of claim 14, wherein the battery pack includes lithium-ion pouch cells.

16. The method of claim 14, wherein the barrier includes carbon fiber.

17. The method of claim 14, wherein the barrier includes carbon fiber in a sheet form.

18. The method of claim 14, wherein the barrier includes carbon fiber in an epoxy form.

19. The method of claim 14, wherein the barrier is configured to cool down a thermal energy of the lithium ejecta.

20. The method of claim 14, wherein the sensor board includes a temperature sensor.
